(19) United States
(12) Patent Application Publication
(10) Pub. No.: US 2019/0213446 A1
(43) Pub. Date: Jul. 11, 2019

(54) DEVICE-BASED ANOMALY DETECTION USING RANDOM FOREST MODELS

(71) Applicant: Intel Corporation, Santa Clara, CA (US)

(72) Inventors: Yu-Lin Tsou, New Taipei City (TW); Shao-Wen Yang, San Jose, CA (US)

(73) Assignee: Intel Corporation, Santa Clara, CA (US)

(21) Appl. No.: 16/306,502

(22) PCT Filed: Jun. 30, 2016
(86) PCT No.: PCT/US2016/040259

§ 371 Date: Nov. 30, 2018

(51) Int. Cl. G06K 9/62; G06N 20/20; G06N 5/04; H04W 4/70

(52) U.S. Cl. CPC G06K 9/6257; G06K 9/6282; H04W 4/70; G06N 5/045; G06N 20/20

(57) ABSTRACT

Training data generated at a particular device deployed in a machine-to-machine network is used to train a first plurality of decision trees for inclusion in a random forest model for use in anomaly detection. Copies of the trained first plurality of decision trees are sent to at least one other device deployed in the machine-to-machine network and copies of a second plurality of decision trees are received from the other device, which were trained at the other device using training data generated by the other device. The random forest model is generated to include the first and second plurality of decision trees. The random forest model is used by the particular device to detect anomalies in data generated by the particular device.

### TECHNICAL FIELD

This disclosure relates in general to the field of computer systems and, more particularly, to managing machine-to-machine systems.

### BACKGROUND

The Internet has enabled interconnection of different computer networks all over the world. While previously, Internet-connectivity was limited to conventional general purpose computing systems, ever increasing numbers and types of products are being redesigned to accommodate connectivity with other devices over computer networks, including the Internet. For example, smart phones, tablet computers, wearables, and other mobile computing devices have become very popular, even supplanting larger, more traditional general purpose computing devices, such as traditional desktop computers in recent years. Increasingly, tasks traditionally performed on a general purpose computers are performed using mobile computing devices with smaller form factors and more constrained features sets and operating systems. Further, traditional appliances and devices are becoming “smarter” as they are ubiquitous and equipped with functionality to connect to or consume content from the Internet. For instance, devices, such as televisions, gaming systems, household appliances, thermostats, automobiles, watches, have been outfitted with network adapters to allow the devices to connect with the Internet (or another device) either directly or through a connection with another computer connected to the network. Additionally, this increasing universe of interconnected devices has also facilitated an increase in computer-controlled sensors that are likewise interconnected and collecting new and large sets of data. The interconnection of an increasingly large number of devices, or “things,” is believed to foreshadow an era of advanced automation and interconnectivity, referred to, sometimes, as the Internet of Things (IoT).

### BRIEF DESCRIPTION OF THE DRAWINGS

FIG. 1 illustrates an embodiment of a system including multiple sensor devices and an example management system.

FIG. 2 illustrates an embodiment of a system including an example management system.

FIG. 3 is a simplified flow diagram illustrating an example of using an anomaly detection model to predict anomalies at a device.

FIG. 4 is a simplified flow diagram illustrating an example generation of anomaly data for use in anomaly detection model training.

FIG. 5 is a simplified block diagram illustrating decision tree sharing within an example machine-to-machine system.

FIG. 6 is a simplified block diagram illustrating example development of a random forest for anomaly detection.

FIG. 7 is a simplified block diagram illustrating example detection of anomalies on a device of an example machine-to-machine system.

FIG. 8 is a simplified block diagram illustrating an example of a distributed framework for developing anomaly detection models.

FIG. 9 is a flowchart illustrating an example technique for developing and using a random forest-based anomaly detection model for detecting anomalies at a device.

FIG. 10 is a block diagram of an exemplary processor in accordance with one embodiment; and

FIG. 11 is a block diagram of an exemplary computing system in accordance with one embodiment.

Like reference numbers and designations in the various drawings indicate like elements.

### DETAILED DESCRIPTION OF EXAMPLE EMBODIMENTS

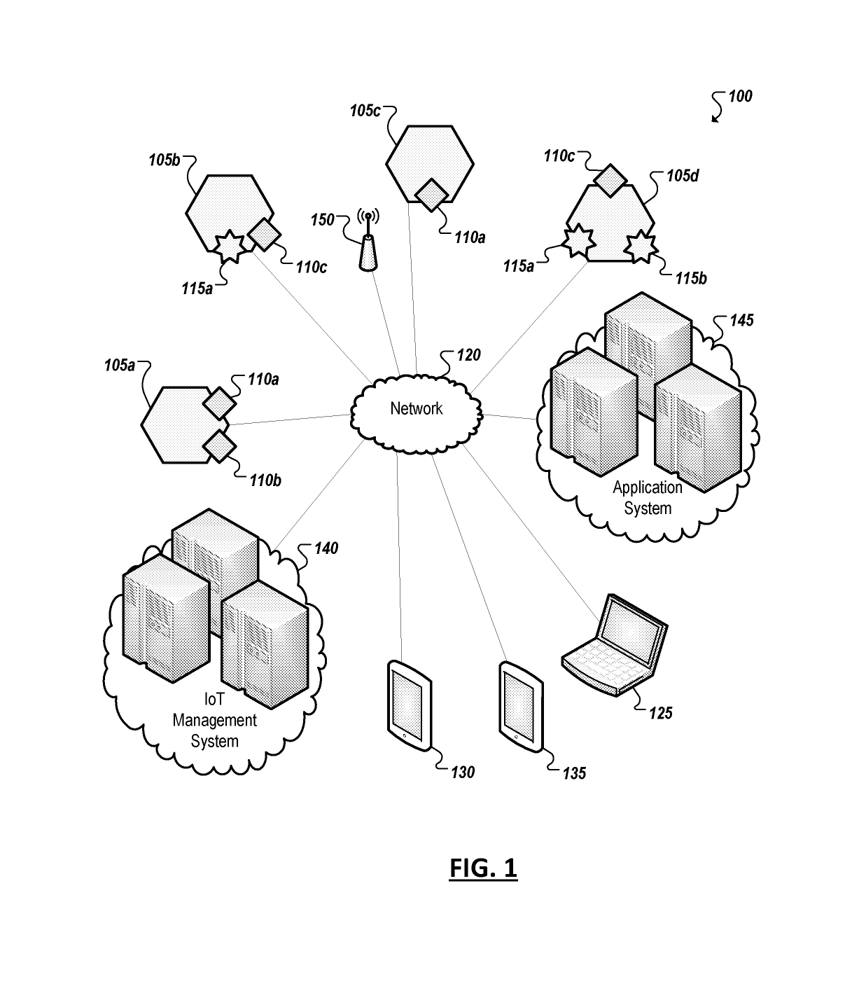

FIG. 1 is a block diagram illustrating a simplified representation of a system 100 that includes one or more devices 105a-d, or assets, deployed throughout an environment. Each device 105a-d may include a computer processor and/or communications module to allow each device 105a-d to interoperate with one or more other devices (e.g., 105a-d) or systems in the environment. Each device can further include one or more instances of various types of sensors (e.g., 110a-c), actuators (e.g., 115a-b), storage, power, computer processing, and communication functionality which can be leveraged and utilized (e.g., by other devices or software) within a machine-to-machine, or Internet of Things (IoT) system or application. In some cases, inter-device communication and even deployment of an IoT application may be facilitated by one or more gateway devices (e.g., 150) through which one or more of the devices (e.g., 105a-d) communicate and gain access to other devices and systems in one or more networks (e.g., 120).

Sensors, or sensor assets, are capable of detecting, measuring, and generating sensor data describing characteristics of the environment in which they reside, are mounted, or are in contact with. For instance, a given sensor (e.g., 110a-c) may be configured to detect one or more respective characteristics such as movement, weight, physical contact, temperature, wind, noise, light, computer communications, wireless signals, position, humidity, the presence of radiation, liquid, or specific chemical compounds, among several other examples. Indeed, sensors (e.g., 110a-c) as described herein, anticipate the development of a potentially limitless universe of various sensors, each designed to and capable of detecting, and generating corresponding sensor data for, new and known environmental characteristics. Actuators (e.g., 115a-b) can allow the device to perform some kind of action to affect its environment. For instance, one or more of the devices (e.g., 105b,d) may include one or more respective actuators that accepts an input and perform its respective action in response. Actuators can include controllers to activate additional functionality, such as an actuator to selectively toggle the power or operation of an alarm, camera (or other sensors), heating, ventilation, and air conditioning (HVAC) appliance, household appliance, in-vehicle device, lighting, among other examples.

In some implementations, sensors 110a-c and actuators 115a-b provided on devices 105a-d can be assets incorporated in and/or forming an Internet of Things (IoT) or machine-to-machine (M2M) system. IoT systems can refer to new or improved ad-hoc systems and networks composed of multiple different devices interoperating and synergizing to deliver one or more results or deliverables. Such ad-hoc systems are emerging as more and more products and equipment evolve to become “smart” in that they are controlled or monitored by computing processors and provided with facilities to communicate, through computer-implemented mechanisms, with other computing devices (and products having network communication capabilities). For instance, IoT systems can include networks built from sensors and communication modules integrated in or attached to “things” such as equipment, toys, tools, vehicles, etc. and even living things (e.g., plants, animals, humans, etc.). In some instances, an IoT system can develop organically or unexpectedly, with a collection of sensors monitoring a variety of things and related environments and interconnecting with data analytics systems and/or systems controlling one or more other smart devices to enable various use cases and application, including previously unknown use cases. Further, IoT systems can be formed from devices that hitherto had no contact with each other, with the system being composed and automatically configured spontaneously or on the fly (e.g., in accordance with an IoT application defining or controlling the interactions). Further, IoT systems can often be composed of a complex and diverse collection of connected devices (e.g., 105a-d), such as devices sourced or controlled by varied groups of entities and employing varied hardware, operating systems, software applications, and technologies. In some cases, a gateway (e.g., 150) may be provided to localize a particular IoT system, with the gateway 150 able to detect nearby devices (e.g., 105a-d) and deploy (e.g., in an automated, impromptu manner) an instance of a particular IoT application by orchestrating configuration of these detected devices to satisfy requirements of the particular IoT application, among other examples.

Facilitating the successful interoperability of such diverse systems is, among other example considerations, an important issue when building or defining an IoT system. Software applications can be developed to govern how a collection of IoT devices can interact to achieve a particular goal or service. In some cases, the IoT devices may not have been originally built or intended to participate in such a service or in cooperation with one or more other types of IoT devices. Indeed, part of the promise of the Internet of Things is that innovators in many fields will dream up new applications involving diverse groupings of the IoT devices as such devices become more commonplace and new “smart” or “connected” devices emerge. However, the act of programming, or coding, such IoT applications may be unfamiliar to many of these potential innovators, thereby limiting the ability of these new applications to be developed and come to market, among other examples and issues.

As shown in the example of FIG. 1, multiple IoT devices (e.g., 105a-d) can be provided from which one or more different IoT application deployments can be built. For instance, a device (e.g., 105a-d) can include such examples as a mobile personal computing device, such as a smart phone or tablet device, a wearable computing device (e.g., a smart watch, smart garment, smart glasses, smart helmet, headset, etc.), purpose-built devices such as and less conventional computer-enhanced products such as home, building, vehicle automation devices (e.g., smart heat-ventilation-air-conditioning (HVAC) controllers and sensors, light detection and controls, energy management tools, etc.), smart appliances (e.g., smart televisions, smart refrigerators, etc.), and other examples. Some devices can be purpose-built to host sensor and/or actuator resources, such as a weather sensor devices that include multiple sensors related to weather monitoring (e.g., temperature, wind, humidity sensors, etc.), traffic sensors and controllers, among many other examples. Some devices may be statically located, such as a device mounted within a building, on a lamppost, sign, water tower, secured to a floor (e.g., indoor or outdoor), or other fixed or static structure. Other devices may be mobile, such as a sensor provisioned in the interior or exterior of a vehicle, in-package sensors (e.g., for tracking cargo), wearable devices worn by active human or animal users, an aerial, ground-based, or underwater drone among other examples. Indeed, it may be desired that some sensors move within an environment and applications can be built around use cases involving a moving subject or changing environment using such devices, including use cases involving both moving and static devices, among other examples.

Continuing with the example of FIG. 1, software-based IoT management platforms can be provided to allow developers and end users to build and configure IoT applications and systems. An IoT application can provide software support to organize and manage the operation of a set of IoT devices for a particular purpose or use case. In some cases, an IoT application can be embodied as an application on an operating system of a user computing device (e.g., 125), a mobile app for execution on a smart phone, tablet, smart watch, or other mobile device (e.g., 130, 135), a remote server, and/or gateway device (e.g., 150). In some cases, the application can have or make use of an application management utility allowing users to configure settings and policies to govern how the set devices (e.g., 105a-d) are to operate within the context of the application. A management utility can also be used to orchestrate the deployment of a particular instance of an IoT application, including the automated selection and configuration of devices (and their assets) that are to be used with the application. A management utility may also manage faults, outages, errors, and other anomalies detected on the various devices within an IoT application deployment. Anomalies may be reported to the management utility, for instance, by the IoT devices as they determine such anomalies. A management utility may additionally assist IoT devices with anomaly detection. Devices may utilize anomaly detection models, which may be provided or developed with assistance of a management utility, among other examples.

In some cases, an IoT management application may be provided (e.g., on a gateway, user device, or cloud-based server, etc.), which can manage potentially multiple different IoT applications or systems. Indeed, an IoT management application, or system, may be hosted on a single system, such as a single server system (e.g., 140), a single end-user device (e.g., 125, 130, 135), or a single gateway device (e.g., 150), among other examples. Alternatively, an IoT management system can be distributed across multiple hosting devices (e.g., 125, 130, 135, 140, 150, etc.).

As noted above, IoT applications may be localized, such that a service is implemented utilizing an IoT system (e.g., of devices 105a-d) within a specific geographic area, room, or location. In some instances, IoT devices (e.g., 105a-d) may connect to one or more gateway devices (e.g., 150) on which a portion of management functionality (e.g., as shared with or supported by management system 140) and a portion of application service functionality (e.g., as shared with or supported by application system 145). Service logic and configuration data may be pushed (or pulled) to the gateway device 150 and used to configure IoT devices (e.g., 105a-d, 130, 135, etc.) within range or proximity of the gateway device 150 to allow the set of devices to implement a particular service within that location. A gateway device (e.g., 150) may be implemented as a dedicated gateway element, or may be a multi-purpose or general purpose device, such as another IoT device (similar to devices 105a-d) or user device (e.g., 125, 130, 135) that itself may include sensors and/or actuators to perform tasks within an IoT system, among other examples.

In some cases, applications can be programmed, or otherwise built or configured, utilizing interfaces of an IoT management system or a dedicated IoT application development platform. In some cases, IoT application development tools can adopt asset abstraction to simplify the IoT application building process. For instance, users can simply select classes, or taxonomies, of devices and logically assemble a collection of select devices classes to build at least a portion of an IoT application (e.g., without having to provide details regarding configuration, device identification, data transfer, etc.). IoT application development tools may further utilize asset abstraction to develop and define deployment of one or more graphical user interfaces (GUIs) for use in a deployment of the resulting IoT application, to allow user control and management of a deployment during runtime. Further, IoT application systems built using the IoT management system can be sharable, in that a user can send data identifying the constructed system to another user, allowing the other user to simply port the abstracted system definition to the other user's environment (even when the combination of device models is different from that of the original user's system). Additionally, system or application settings, defined by a given user, can be configured to be sharable with other users or portable between different environments, among other example features.

In some cases, IoT systems can interface (through a corresponding IoT management system or application or one or more of the participating IoT devices) with remote services, such as data storage, information services (e.g., media services, weather services), geolocation services, and computational services (e.g., data analytics, search, diagnostics, etc.) hosted in cloud-based and other remote systems (e.g., 140, 145). For instance, the IoT system can connect (e.g., directly or through a gateway 150) to a remote service (e.g., 145) over one or more networks 120. In some cases, the remote service can, itself, be considered an asset of an IoT application. Data received by a remotely-hosted service can be consumed by the governing IoT application and/or one or more of the component IoT devices to cause one or more results or actions to be performed, among other examples.

One or more networks (e.g., 120) can facilitate communication between sensor devices (e.g., 105a-d), end user devices (e.g., 123, 130, 135), gateways (e.g., 150), and other systems (e.g., 140, 145) utilized to implement and manage IoT applications in an environment. Such networks can include wired and/or wireless local networks, public networks, wide area networks, broadband cellular networks, the Internet, and the like.

In general, “servers,” “clients,” “computing devices,” “network elements,” “hosts,” “system-type system entities,” “user devices,” “gateways,” “IoT devices,” “sensor devices,” and “systems” (e.g., 105a-d, 125, 130, 135, 140, 145, 150, etc.) in example computing environment 100, can include electronic computing devices operable to receive, transmit, process, store, or manage data and information associated with the computing environment 100. As used in this document, the term “computer,” “processor,” “processor device,” or “processing device” is intended to encompass any suitable processing apparatus. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

As noted above, a collection of devices, or endpoints, may participate in Internet-of-things (IoT) networking, which may utilize wireless local area networks (WLAN), such as those standardized under IEEE 802.11 family of standards, home-area networks such as those standardized under the Zigbee Alliance, personal-area networks such as those standardized by the Bluetooth Special Interest Group, cellular data networks, such as those standardized by the Third-Generation Partnership Project (3GPP), and other types of networks, having wireless, or wired, connectivity. For example, an endpoint device may also achieve connectivity to a secure domain through a bus interface, such as a universal serial bus (USB)-type connection, a High-Definition Multimedia Interface (HDMI), or the like.

In some instances, a cloud computing network, or cloud, in communication with a mesh network of IoT devices (e.g., 105a-d), which may be termed a “fog,” may be operating at the edge of the cloud. A fog, in some instances, may be considered to be a massively interconnected network wherein a number of IoT devices are in communications with each other, for example, by radio links. This may be performed using the open interconnect consortium (OIC) standard specification 6.0 released by the Open Connectivity Foundation™ (OCF) on Dec. 23, 2015. This standard allows devices to discover each other and establish communications for interconnects. Other interconnection protocols may also be used, including, for example, the optimized link state routing (OLSR) Protocol, or the better approach to mobile ad-hoc networking (B.A.T.M.A.N.), among others.

While FIG. 1 is described as containing or being associated with a plurality of elements, not all elements illustrated within computing environment 100 of FIG. 1 may be utilized in each alternative implementation of the present disclosure. Additionally, one or more of the elements described in connection with the examples of FIG. 1 may be located external to computing environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

With the emergence of Internet of Things (IoT) system, it is anticipated that over 50 billion devices will be available to be interconnected by the year 2020, potentially enabling enormous and world-changing opportunities in terms of technology breakthrough and business development. For instance, in home automation systems, automation of a home is typically increased as more IoT devices are added for use in sensing and controlling additional aspects of the home. However, as the number and variety of devices increase, the management of “things” (or devices for inclusion in IoT systems) becomes outstandingly complex and challenging.

One of the major obstacles preventing the adoption of IoT systems is the reality that many of the various (and sometimes special purpose) IoT devices may be rather unreliable in the following aspects.
Some devices are to be operated in harsh environments. Sensor readings can drift in extreme environments, e.g., at 120 degree Fahrenheit, in a rainy day, etc.;
Devices may be per se unreliable. Many IoT devices are designed for consumers, which may imply lower cost, lower durability, and lower overall reliability;
Some devices run on unreliable power sources. Many IoT devices, to preserve their mobility and flexibility of deployment, utilize battery power (e.g., in the absence of a convenient or consistent wired power source), leading to reliance on battery lifespan for reliably device performance;
Unreliable network connectivity. As many IoT devices may be deployed beyond the reach of a wired network connection, wireless network connectivity is relied upon, which may sometimes be unreliable and intermittent; among other examples.
   All of the above issues may lead to unpredictable or anomalous sensor readings, e.g., value drifting, random value, null value, etc., which hereinafter may be referred to as “anomalies” or “outliers”.

A system may be provided with functionality to allow anomalies be identified, which affect certain devices or particular sensor or actuators of these devices. Anomaly detection may trigger service events to prompt a machine or humans to take action in response to the anomalies. In some implementations, anomaly detection may be carried out at the device, allowing the device itself to determine an anomaly. Detecting anomalies may involve monitoring each of the various types of data generated at the device to determine when data deviates from what is expected. However, rather than passing this data to an outside service (e.g., a management utility) for anomaly detection, by performing anomaly detection on the device (i.e., the source of the data), an anomaly detection scheme may be provided that foregoes use of valuable communication bandwidth. For instance, a device may have limited bandwidth capabilities and, in the case of battery powered devices, continuous network communications may diminish the battery and overall lifespan of the device, among other example issues. Further, many IoT devices may be subject to bounded computation resources (e.g., to preserve battery power, etc.). In one example, device-based anomaly detection in the context of an IoT (or wireless sensor network (WSN)) system may be provided through a distributed framework for anomaly detection using one-class random forests to realize optimized bandwidth requirements and reduced computational overhead for devices in the IoT or WSN system.

A distributed, one-class random forest may be utilized as an anomaly detection model capable of being used at the device for local anomaly detections. A one-class classification may reduce an unsupervised problem to a supervised learning problem for online prediction by sampling outliers from a priori distributions. By their nature, it may difficult to organically obtain positive (anomalous) data points from a dataset and thereby obtain corresponding labels. One-class classification, through an artificially generated set of anomalous data points, may address these issues. Using a random forest as the corresponding supervised learning technique may further address the problem of bounded bandwidth and bounded computation. In terms of bandwidth, random forests may abstract data into compact models. Accordingly, rather than sending all device data over the network, bandwidth use may be minimized to achieve anomaly detection by limiting anomaly detection traffic to the exchange of models between devices (or a backend providing such models) and the reporting of anomalies detected at the devices. In terms of computation, a random forest provides a set of decision trees that allow computational efficient decision-making at the device (e.g., compared to support vector machines (SVM), kernel-based, and other solutions). The sharing of models between devices may implement a distributed framework that emerges as another example advantage of random forests. A random forest may be based on bagging, feature sampling and ensemble. Ensemble is a mechanism of combining multiple decision trees for decision making. Based on the fact that real time decision making usually rely on spatial and temporal locality, it is straightforward to generalize random forests to IoT or WSN systems such that every device only communicates with their nearby (and/or functionally similar) devices for ensembling, among other examples.

A distributed, one-class random forest anomaly detection model may achieve benefits of other anomaly detection schemes. For instance, many state of the art anomaly detection algorithms may be unsupervised and offline and lack up-to-date and positive samples. One-class classification may resolve at least some of these example issues. One-class classification, however, may mandates a significant number of positive exemplar (anomaly) sampling, which can introduce outstanding complexity in space and time in the training time (e.g., one-class SVM). Random forests using random selection of features can effectively reduce the number of desired positive samples as they are only sampled in a subspace of the feature space. Random forest's bagging also may make training and testing more robust against outliers. This, in effect, may further reduce the computational overhead and bandwidth requirement. Additionally, random forests using ensemble may serve well as a foundation for a distributed anomaly detection framework. The state of the art anomaly detection algorithms are typically centralized (e.g., performed by a system separate from and on behalf multiple devices), which can utilize outstanding data traffic over the network between all devices and a centralized computational device. By communicating decision tree models of random forests, instead of the data, over the IoT network, reduced bandwidth may achieved. Indeed, in some implementations, communication of decision tree models may be further fine-tuned such that models are only communicated when devices come with spatial coherence (e.g., proximity) or hardware/software coherence (e.g., of a same type), which, in turn, may further minimize the related network traffic introduced to support anomaly detection in a system, among other example advantages and features.

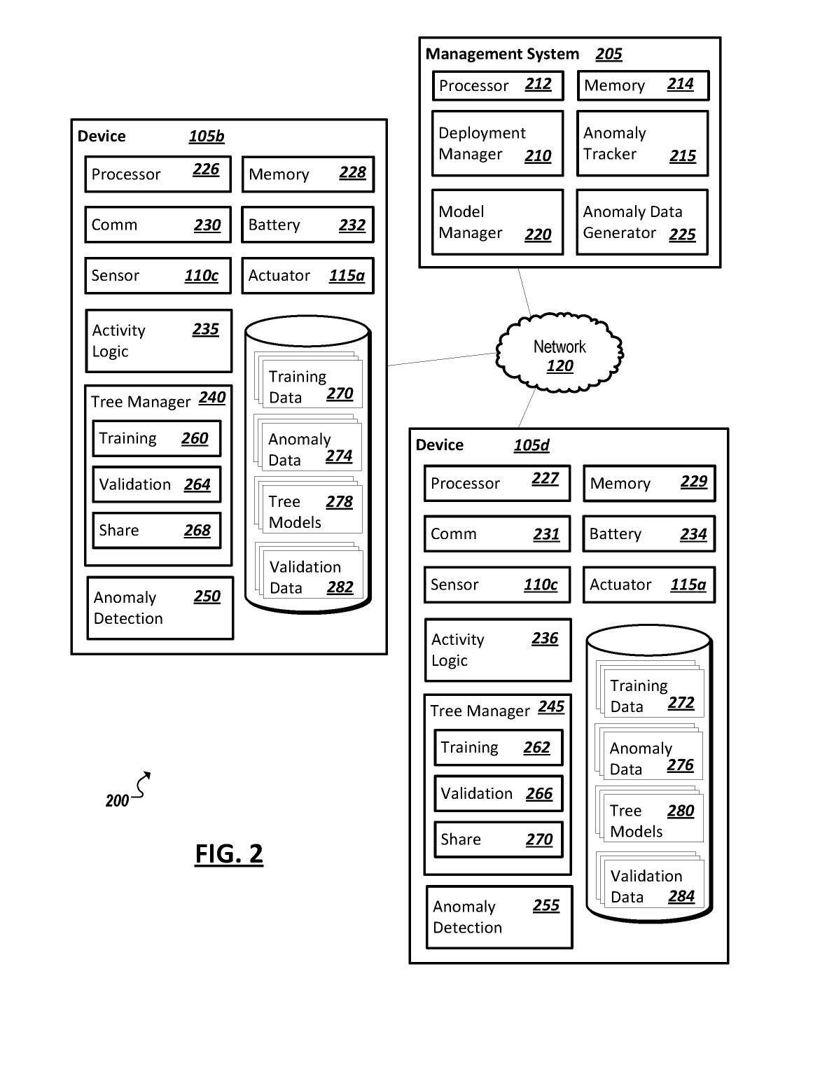

Systems, such as those shown and illustrated herein, can include machine logic implemented in hardware and/or software to implement the solutions introduced herein and address at least some of the example issues above (among others). For instance, FIG. 2 shows a simplified block diagram 200 illustrating a system including multiple IoT devices (e.g., 105b,d) with assets (e.g., sensors (e.g., 110c) and/or actuators (e.g., 115a)) capable of being used in a variety of different IoT applications. In the example of FIG. 2, a management system 205 is provided with deployment manager logic 210 (implemented in hardware and/or software) to detect assets within a location and identify opportunities to deploy an IoT system utilizing the detected assets. Deployment can involve automatically and identifying configuring detected assets to participate in a new or ongoing IoT application deployment. During deployment, or runtime operation of an IoT application, anomalies may occur at any one of the devices (e.g., 105b,d) deployed in the IoT application. Accordingly, a system 200 may be provided with functionality to effectively detect and trigger resolution of anomalies within an IoT system.

In one example, at least a subset of the devices within an IoT or WSN system (e.g., a system where multiple devices are working in concert to provide one or more particular services or results) may include functionality for detecting, at the device, anomalies in data generated at the device. The data in which an anomaly is detected may be data generated by one or more sensors (e.g., 110c) of the device (as they sense the environment corresponding to the device 105b,d), data describing a state or action performed in connection with one or more actuators of the device (e.g., data describing an “open,” “on,” “close,” or other condition), data generated for a user interface of the device (e.g., 105b,d), data generated by activity logic (e.g., 235, 236) of the device (e.g., 105b,d) (e.g., to process sensor data, actuator state data, or other data locally at the device to realize a further outcome or activity at the device, etc.), among other potential examples.

In the particular example of FIG. 2, a device (e.g., 105b,d) may include one or more data processing apparatus (or “processors”) (e.g., 226, 227), one or more memory elements (e.g., 228, 229), one or more communications modules (e.g., 230, 231), a battery (e.g., 232, 233) or other power source (e.g., a solar cell, etc.), among other components. Each device (e.g., 105a,b) can possess hardware, sensors (e.g., 110c), actuators (e.g., 115a), and other logic (e.g., 235, 236) to realize the intended function(s) of the device (including operation of the respective sensors and actuators). In some cases, devices may be provided with such assets as one or more sensors of the same or varying types, actuators (e.g., 115a) of varying types, computing assets (e.g., through a respective processor and/or software logic), security features, data storage assets, and other resources. Communication modules (e.g., 203, 231) may also be utilized as communication assets within some deployments and may include hardware and software to facilitate the device's communication over one or more networks (e.g., 120), utilizing one or more technologies (e.g., WiFi, Bluetooth, Near Field Communications, Zigbee, Ethernet, etc.), with other systems and devices.

In one example, a device (e.g., 105b,d) may be further provided with anomaly detection logic (e.g., 250, 255) to utilize a locally-stored anomaly detection model to determine when data generated at the device (e.g., 105b,d) constitutes an anomaly. In some instances, a random forest-based anomaly detection model may be utilized by the anomaly detection logic 250, 255 to detect anomalies in device data. A tree manager 240, 245 may be provided on a device (e.g., 105b,d) to perform tasks relating to the generation, training, validation, maintenance, and use of decision trees and random forests generated for use by anomaly detection logic 250, 255. For instance, in one example, a tree manager 240 may include sub-components such as training logic 260, 262, validation logic 264, 266, and tree sharing logic 268, 270, among other examples.

In the example of FIG. 2, a tree manager 240 may access decision tree models (e.g., 278, 280) and may train each of the trees 278, 280 using training data 270, 272. The decision trees themselves may be provided, for instance, by a management system 205 or other remote system (e.g., through an anomaly detection model manager 220 of the system configured to provision endpoint or IoT devices (e.g., 105b,d) with decision tree instances. The training data 270, 272 may be data generated at the corresponding device (e.g., during test or live operation in connection with sensors (e.g., 110c), actuators (e.g., 115a), and/or activity logic (e.g., 235, 236) of the respective device). Given that anomalies may be outliers (and not likely to be comprehensively captured in training data 270, 272 (if at all)), to more effectively train the tree models (e.g., 278, 280) training logic 260, 262 may also utilize artificially generated anomaly data (e.g., 274, 276) corresponding to data expected when certain anomalies, device errors, faults, outages, or other issues occur that affect the device (e.g., 105b,d). Anomaly data (e.g., 274, 276) may likewise be generated and provided by an outside source, such as a management system (e.g., 205) or other system (e.g., using an anomaly data generator (e.g., 225)). In other cases, as the anomaly data may be generated from training data (e.g., 270, 272) generated at the device (e.g., 105b,d), an anomaly data generator may instead or additionally be provided locally at the device (e.g., 105b,d) in some implementations.

The tree models (e.g., 278, 280) provided on any one device (e.g., 105b,d) within an IoT or WSN system may represent only a subset of decision trees available to detect anomalies for a device or particular type of device. Indeed, the respective decision tree models (e.g., 278) hosted on a device (e.g., 105b) may be different from the decision tree models (e.g., 280) hosted on other related devices (e.g., 105d). A tree manager 240, 245 may further possess validation logic 264, 266 to utilize validation data (e.g., 282, 284) to validate the various decision trees (e.g., 278, 280) it maintains or otherwise has access to (e.g., other trees it receives from other related devices). The validation data 282, 284 may be specific to the device (e.g., 105b, 105d) and generated from data (e.g., training data) generated by the device. Through validation, a weighting can be determined for each of the decision trees, which may be utilized by anomaly detection logic 250, 255 in performing voting of a random forest generated from the aggregate decision trees (e.g., 278, 280). Indeed, sharing logic (e.g., 268, 270) may be provided to identify other devices within a particular IoT application or WSN deployment with decision trees relevant to the device. A device (e.g., 105b) may utilize sharing logic (e.g., 268) to receive related decision trees (e.g., 280) from other devices (e.g., 105d) and further utilize sharing logic to share its own locally trained and developed decision trees (e.g., 278) with other related devices (e.g., 105d). Each of the devices (e.g., 105b,d) may thereby build a random forest anomaly detection model from the trees it develops and receives and utilize this random forest anomaly detection model to detect anomalies occurring at the device (e.g., using anomaly detection logic 250, 255). As anomalies are detected, these anomaly events may be logged and shared with a management system 205 or other system to trigger an assessment and/or resolution of the anomaly.

In the particular example of FIG. 2, the management system 205 may likewise include one or more processors (e.g., 212), one or more memory elements (e.g., 214), and one or more communication modules incorporating hardware and logic to allow the management system 205 to communicate over one or more networks (e.g., 120) with other systems and devices (e.g., 105b, 105d, etc.). The deployment manager 210 (and other components) may be implemented utilizing code executable by the processor 212 to manage the automated deployment of a local IoT system. Additional components may also be provided to assist with anomaly detection and reporting in one or more IoT application deployments (including deployments not directly assisted by the management system). For instance, a management system 205 may include components such as an anomaly tracker 215, anomaly model manager 220, and anomaly data generator 225, among other example components and features.

As noted above, an anomaly tracker 215 may be provided to receive anomaly events and corresponding data from a collection of devices (e.g., 105b,d) having local anomaly detection logic (e.g., 250, 255). The anomaly tracker 215 may log the reported anomalies and may determine maintenance or reporting events based on the receipt of one or more anomalies. For instance, an anomaly tracker 215 may include functionality for applying a threshold or heuristic to determine an event from multiple anomalies reported by the same or different (nearby or otherwise related) devices (e.g., 105b,d). The anomaly tracker 215 may additionally trigger service tickets, alerts, or other actions based on receiving one or more reported anomalies from the devices (e.g., 105b,d).

A management system 205 may likewise include a model manager 220 with functionality for assisting in the provisioning and development of decision trees and random forest based anomaly detection models locally on collections of devices (e.g., 105b,d) to support local detection of device data anomalies. In some instances, the model manager may merely provide the base decision trees (e.g., 278, 280) to each of the devices 105b,d. The model manager 220, in one example, may randomly select a number of decision trees and then distribute these trees to the collection of devices. In some implementations, the model manager 220 may ensure that distribution of the trees is completed so that groups of devices (e.g., that will be sharing decision trees and building random forests from these trees) do not have duplicate trees within the group. In some instances, one or more functions of a tree manager (e.g., 240, 245) may be supplemented by or replaced by functionality of the model manager 220. In some implementations, devices (e.g., 105b,d) may provide training data to a centralized management system 205 to allow a centralized model manager 220 to perform training (and even validation) of the decision trees and then distribute these (trained and validated) decision trees to the respective devices (e.g., 105b,d) among other example implementations. A management system 205 may additionally include an anomaly data generator 225 to generate anomaly data for use in training of decision tree models. In implementations where the decision trees are trained at the devices, the anomaly data generator 225 may provide respective anomaly data to various devices that is relevant to the types of anomalies, which may occur on these devices.

In some cases, the management system 205 may be implemented on a dedicated physical system (e.g., separate from other devices in the IoT deployment). For instance, the management system 205 may be implemented on a gateway device used to facilitate communication with and between multiple potential IoT devices (e.g., 105b,d) within a particular location. In some instances, the management system 205 may be hosted at least in part on a user device (e.g., a personal computer or smartphone), including a user device that may itself be utilized in the deployment of a particular IoT application. Indeed, the management system 205 (and deployment manager 210) may be implemented on multiple devices, with some functionality of the management system 205 hosted on one device and other functionality hosted on other devices. A management system 205 may, in some cases, be hosted partially or entirely remote from the environment in which the IoT or WSN devices (e.g., 105b,d) are to be deployed. Indeed, a management system 205 may be implemented using one or more remote computing systems, such as cloud-based resources, that are remote from the devices, gateways, etc. utilized in a given IoT application or WSN deployment.

In an IoT, WSN, or other M2M systems where anomalies are generally or by definition uncommon, anomaly detection may be challenging problem since the differentiation and labeling of anomalies within a data set is not present, making it an unsupervised learning problem in machine learning. Further complicating this issue is the difficulty in obtaining (from the data actually generated by the devices) positive samples of anomalies. In some cases, all data generated by a device or set of devices in a training data set may be assumed to be negative samples (i.e., normal data points). This set of “normal data” may be analyzed to determine a pattern corresponding to normal data generation, resulting in a one-class classification. This one-class classification data set can be applied to a learning framework (supported by the devices themselves, the assistance of a management system, or in some cases the devices and management system in tandem) in order reduce the anomaly detection problem to a one-class supervised learning problem.

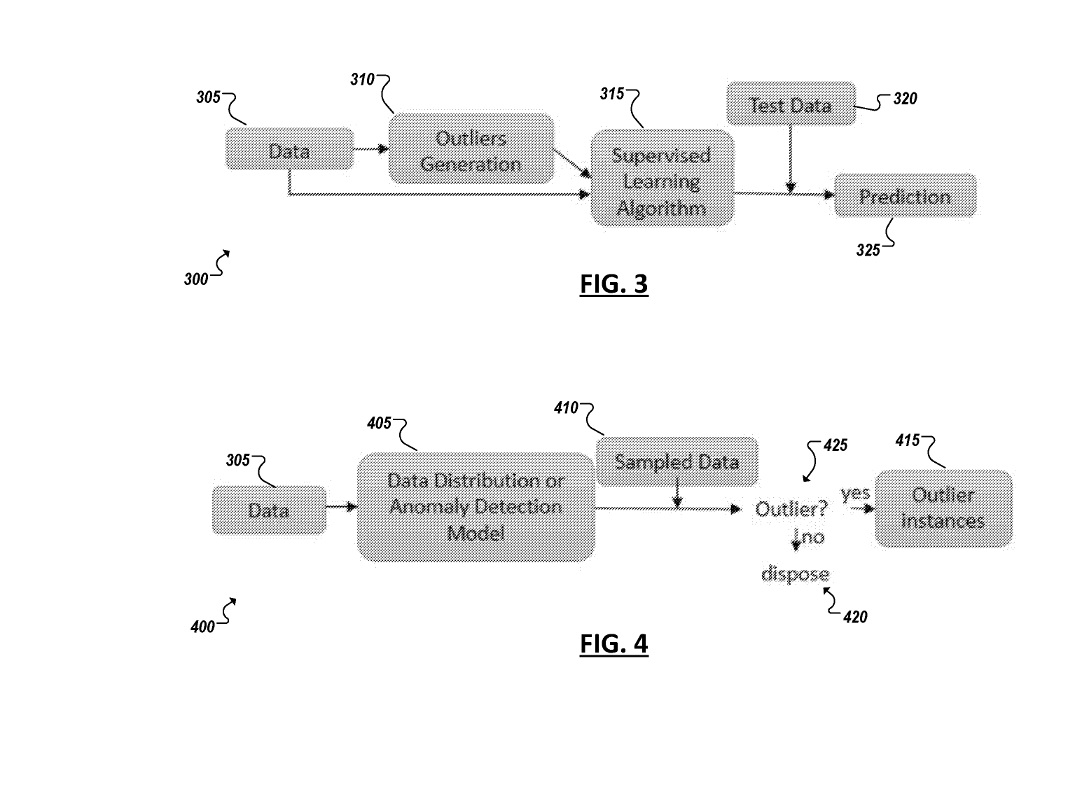

FIG. 3 shows a representative flow of one example of such a learning framework. For instance, training data 305 may be provided as generated at a device (e.g., in connection with the operation of its sensors, actuators, and/or device logic) and used as the basis for artificially generating 310 outlier (i.e., positive anomaly) data (e.g., which is based on deviations from a pattern determined from the training data 305). The resulting anomaly data may be combined with the training data 305 to form a training set that may be processed by a supervised learning module 315 (e.g., utilizing any one of a variety of acceptable supervised learning algorithms). For instance, by combining the training data set (assumed to be completely negative (normal) samples) with the artificially generated positive samples, as shown in FIG. 3, a label (normal or anomaly) may be applied to each data instance and a supervised learning model may thus be trained based on these instances. The resulting model (e.g., a random forest-based model) may then be used to perform anomaly detection on testing data 320 (e.g., data generated at the device following training and subjected to anomaly detection) to predictably determine 325 anomalies occurring in the testing data 320.

In FIG. 4, a simplified block diagram 400 is shown illustrating the flow of example anomaly data generation from a training data 305 (e.g., corresponding to 310 from FIG. 3). Here the training data 305 may be regarded as uniformly normal data, allowing the training data 305 to be utilized by an existing anomaly detection model or probability distribution to determine whether other data values or vectors (e.g., “sample data” 410) constitute an anomaly or not. For example, a multivariate normal distribution may be utilized, first by fitting the training data set to such a distribution and then deriving a probability density function based on the distribution. Other data distributions or anomaly detection models (e.g., 405) may be applied in other examples. A probability density function or anomaly detection model 405 may then be applied to sampled data 410 to determine 425 whether or not the sample is an outlier or not (e.g., according to a given threshold). Any and all data determined to deviate from the distribution of normal data can then be kept 415 as anomaly data to be used in training of anomaly detection models (with any non-anomalous data being discarded 420), among other examples.

As noted above, a variety of machine learning techniques may be applied (e.g., locally at devices of an IoT or WSN system) for anomaly detection, such as support vector machines (SVMs), random forests, and deep neural networks (DNNs). In cases where random forests are used, efficiencies may be realized that are tuned to the limited processing, storage, and communication capabilities of some devices. For instance, random forests tend not to utilize significant amounts of data (e.g., like DNNs), random forests are robust against outliers, random forests are efficient and work well within real time applications (e.g., applications involving localization) and random forest models may be easily implemented as online algorithms, among other potential example benefits.

A random forest is an ensemble model based on a collection of decision trees. Each of the decision trees in the forest may be respectively trained by sub-sampling (i.e., bagging, or randomly selecting portions of a training instance) and then sub-featuring (i.e., randomly selecting features) to randomly select a certain amount of data dimension. For instance, a data instance may include a collection of values {d₁, d₂, . . . dₙ}, the size (or dimension) of which may be constrained through sub-featuring (e.g., selecting a portion of the values, or features, for use in training and development of the anomaly detection model). Multiple different decision trees may be trained using such training data and the trained trees can be combined into an ensemble random forest for an anomaly detection model for use at the device.

Training a decision tree can involve randomly selecting features to assist in reducing the amount of generated positives in training time. Indeed, through sub-featuring, the size of the training data domain may be reduced, leading to a smaller number of possible outliers (that would be present in the original data domain). Accordingly, parameters may be selected to indicate the number of features to be used when training a decision tree. Random selection of features may thereby reduce the amount of generated positives samples in the training time. Further, outlier, or anomaly data, generation may be performed using potentially any data set generated from a corresponding device. Additionally, bagging may provide for improved robustness against the potential noisiness of a dataset. For instance, it is possible that the training set (which is assumed to be entirely normal), actually includes one or more data instances, which are actually anomalies. Through bagging, a device will only train a subset of the decision trees that will be ultimately included in the random forest used for anomaly detection. The remaining trees may be received from other nearby or otherwise related devices through an exchange of trees. These other trees, would not be trained using the same training set (but would instead utilize the training set of data generated at the device from which the tree originates, and thus would not be trained based on the noise data. Indeed, any noisy data in a training set (e.g., should it reappear in testing data) may be classified as an anomaly by these other received trees, even though the noisy data was treated as an inlier during training of the corresponding device's own trees

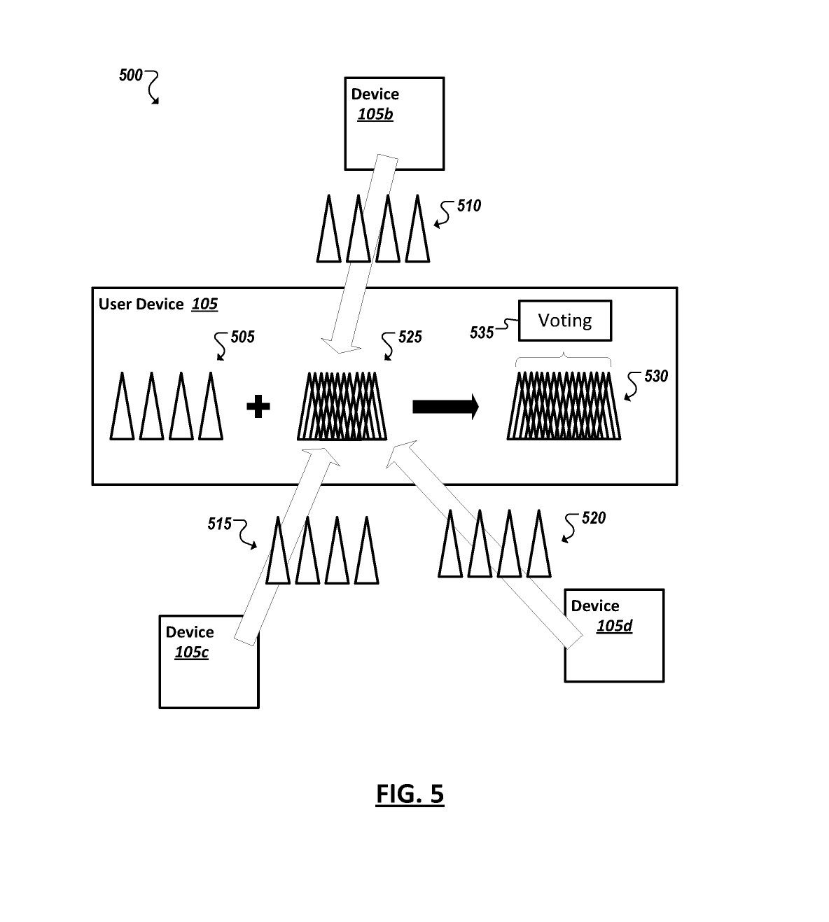

Turning to FIG. 5, a simplified block diagram 500 is shown illustrating the development of an example random forest for use in anomaly detection at a device (e.g., a sensor or actuator device in a larger WSN or IoT system). The device 105a may be provided with a set of decision trees 505, which the device 105a is responsible for training using training data generated at the device 105a. In some cases, the set of (untrained) decision trees 505 may be received by a backend management system or other remote source. In other cases, the device itself may include functionality (e.g., embodied in modules implemented in hardware and/or software) to generate the set of decision trees 505. The device 105a may utilize this training data together with anomaly data to train the set of decision trees 505. The anomaly data may be generated based on the device's training data. In some cases, the anomaly data may be generated from training data from multiple similar (and nearby) devices. An anomaly data generator may be provided on one of the devices (e.g., 105a-c) or by a remote service (e.g., a management system).

In some implementations, training a random-forest based anomaly detection model may involve distributing responsibility for training the set of decision trees of a random forest between multiple different devices (e.g., for which the particular set of decision trees is relevant). As noted above, to train a decision tree, a training data set corresponding to a device may be subsampled and sub-featured and outliers may be generated from the training set. A decision tress model may be trained using the combined set of training data and outlier (or anomaly) data. One or more decision trees (e.g., 505, 510, 515, 520) may be trained on each of multiple related devices (e.g., 105a-d), with each device training its respective decision trees using training data generated at the corresponding device. In some cases, multiple decision trees may be trained on a single device, such that the training steps are repeated multiple times to train a set (or potentially multiple sets) of decision trees (e.g., 505, 510, 515, 520). Once the set of decision trees are trained, a device (e.g., 105a) may receive over a network the trained sets of decision trees (e.g., 510, 515, 520) of other related devices (e.g., 105b-d). The device may also send a copy of its set of trees (e.g., 505) to each of the other related devices in the network. With its own trees (e.g., 505) and those from its neighbors (e.g., 525 (representing the aggregate trees 510, 515, 520)), each device may then have a “complete” set of decision trees from which to build its own random forest model 530 now.

To determine an anomaly result for a data instance, the data instance may be provided to the model for voting 535 using the collection of decision trees. A random forest can be composed of multiple different decision trees, with each decision tree composed of a unique set of decision nodes. Each decision node can correspond to a test or conditional evaluation of a particular feature or value of a data instance. The result of each decision node can cause an evaluation at another subsequent node on corresponding branches of the tree, until a leaf node is reached. For instance, a data instance (e.g., a single value or collection or vector of values) generated at a device (e.g., 105a) may be fed to a root node of each of the trees in the random forest model 530. The results of each node propagate toward the leaf nodes of the trees until a decision is made for that data instance at each decision tree in the random forest 530. The final determination or prediction may be based on the combined decisions of the decision trees, or a vote, in the random forest model 530. In some cases, a mean or median of the decision tree results may be evaluated (e.g., against a threshold determined for the forest model) to determine whether the data instance is an anomaly or not.

As a general matter, the random forest-based anomaly detection model attempts to formulate a model based on a set of devices={dᵢ:i=1 . . . n}, on which multiple sensors are provided which measure a data vector vᵢ^{t}={xᵢⱼ^{t}:j=1 . . . k} at each time t. The anomaly detection model and thresholds (and weighting) applied to the model (e.g., 530) to generate anomaly predictions (e.g., 535) may be according to M={(ƒᵢ, bᵢ): i=1 . . . d} such that for each devices i,

$${f}_{i} , {b}_{i} = arg {min}_{f , b} {\sum }_{t = 1}^{∞} \vert \frac{1}{2} ( sign ( f ( {v}_{i}^{t} ) - b ) + 1 ) - {y}_{i}^{t} \vert$$

where yᵢ^{t}=1 or 0, denoting the ground truth (anomaly or not) of a data instance vᵢ^{t}; where M is the model containing function ƒ (vᵢ^{t}) and bias b.

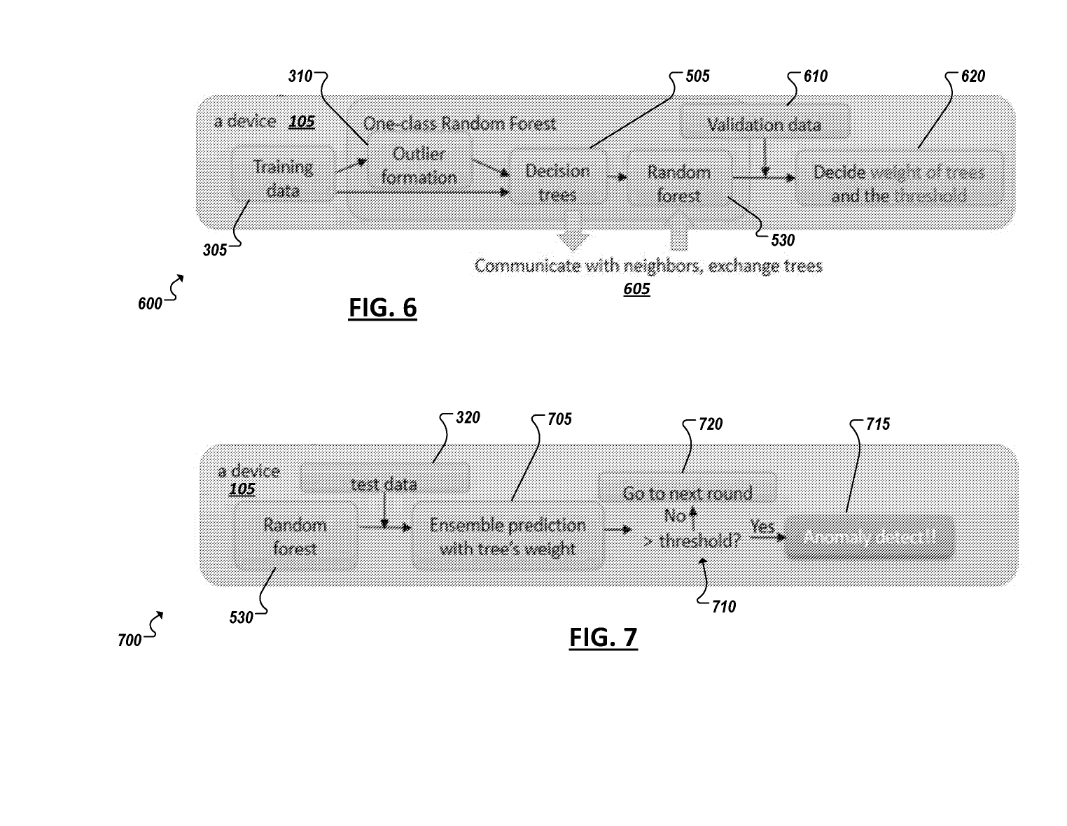

Turning to FIG. 6, a block diagram is shown illustrating training and validation of decision trees for inclusion in an example random tree-based anomaly detection model. Here, a device 105 possesses logic to generate training data 305 and combine the training data with outlier anomaly data generated from the training data (at 310) for use in training of a subset of decision trees 505 to be included in a random forest 530. The decision trees trained at the device may be exchanged (at 605) with other related devices to build the random forest 530. Further, the trees of random forest 530 may be assessed against validation data 610 (e.g., also generated from the training data 305 and/or anomaly data). Normal data may be utilized to generate both the training data 305 and the validation data 610. In one example, a portion of the collected normal data is utilized to generate training data 305 and another portion to generate validation data 610. Validation may be used, in connection with training data to determine (at 620) a weighting to be applied to each tree in the random forest 530. Validation may be further utilized to determine a threshold for a final prediction determined (at 620) from the combined votes of the random forest trees. Validation may be performed independently by each device (e.g., based on its own normal data). In some cases, different weightings and thresholds may be determined during validation of the same random forest as performed by two different devices (utilizing two different validation data sets), among other examples. In one example, validation may involve running the validation data set through the random forest and identifying the highest probability vote (i.e., the probability that a data instance is an anomaly) returned by the random forest during validation. This vote may be adopted as the threshold for the random forest in some implementations.

Turning to the simplified block diagram 700 of FIG. 7, the trained random forest model 530 on a device 105 may be applied to test data 320 (e.g., in real time as it generated by the device 105) and a set of votes may be generated by each of the decision trees in the random forest 530 for each test data instance. The determined weight for each decision tree in the random forest 530 may be applied against the base vote values determined by the trees for a given data instance. In one example, each tree may generate a value between 0 and 1 representing a probability that a data instance is an anomaly (“1”) or not (“0”). The vote may be multiplied by the weighting to generate a final weighted vote. The collection of weighted votes may then be assessed to determine (at 705) a final vote or ensemble prediction (e.g., a median value determined from the combined weighted tree vote values). The ensemble prediction value may then be compared (at 710) to a threshold value determined for the random forest 530 to determine whether the prediction represents a predicted anomaly 715 or a predicted normal data instance 720. If an anomaly is predicted 715, an event may be triggered to report the anomaly to a management system. If a data instance is determined as normal 720, a next data instance may be assessed using the model, and so on.

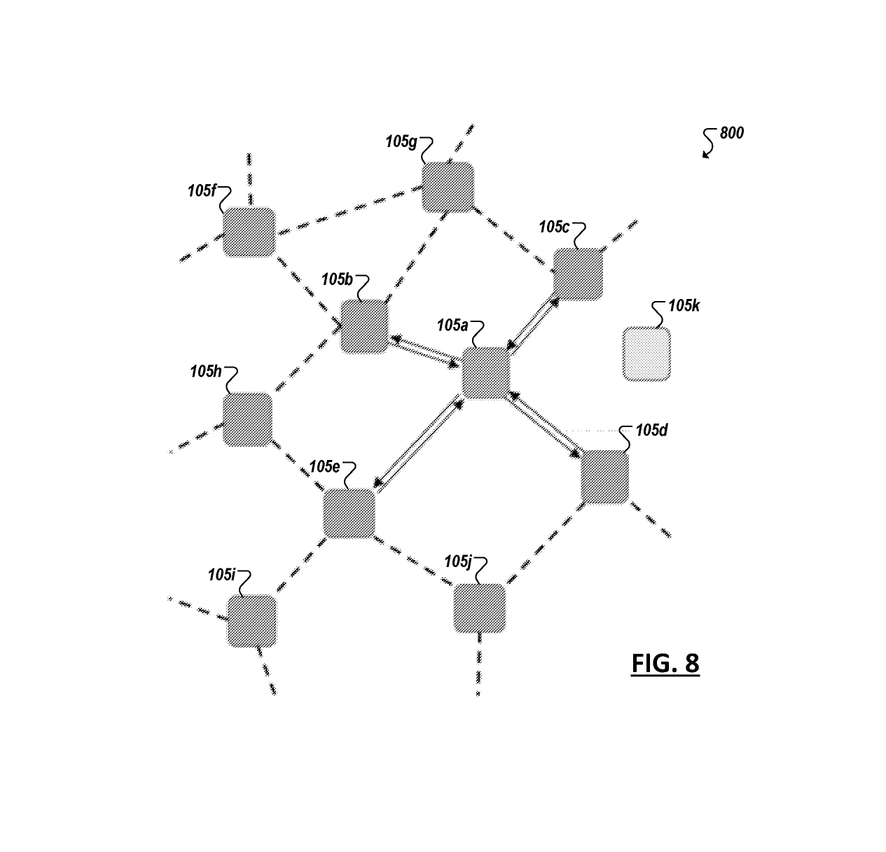

As illustrated in the example of FIG. 5, the training and development of decision trees for incorporation in a random forest-based anomaly detection model may be distributed among multiple devices. In some instances, upon training the device's local decision trees, the device may exchange its trees with other related devices to develop a random forest from the collection of decision trees. For instance, in the simplified block diagram 800 shown in FIG. 8, a collection of devices 105a-k may be present in an environment. In one example, the devices 105a-k may each be deployed in a particular IoT or WSN application such that at least portions of the devices 105a-k may be interconnected, interoperate, and/or intercommunicate (in accordance with the IoT application) to deliver particular outcomes or services. In some cases, the collection of devices 105a-k may include a variety of different devices. For instance, device 105a may be a first type of device with respective sensors and/or actuators, logic, and functionality, while device 105k is a second type of device with different sensors and/or actuators, logic, and functionality. Both types of devices may be deployed in a given IoT application implementation and perform important roles within the deployment. However, each type of device may generate different types of data, or data instances. Accordingly, anomaly detection models generated for a first type of device may not be adapted to detection of anomalies for other types of devices. In still other examples, one or more of the “devices” discussed herein may actually be a collection of discrete physical devices in communication and operating as a single logical device (e.g., being banded together to collectively perform a particular function and capable of being later disbanded to operate as independent devices), among other examples.

In a distributed random forest-based anomaly detection model scheme, random forests may be developed to allow anomaly detection at any one of the set of devices in the system. Decision trees included in one random forest may be configured to predict anomalies appearing in data generated by a first type of device. These decision trees, however, may not be capable of predicting anomalies in data generated by other types of devices. Accordingly, in distributing the training and generation of a particular random forest corresponding to a particular type of device, a device (or management system) may first determine which devices (e.g., 105a-k) should share decision trees with which other devices in the network. The less related devices are, the less relevant decision trees will be that have been developed for and trained by these devices. Accordingly, in one example, a device (e.g., 105a) may detect other devices (e.g., 105b-e and k) in the network and communicate with the devices to discover the capabilities or type of each device. In some instances, the device may additionally query an outside system (such as a management system for the IoT application) to determine the type of neighboring devices. For instance, the device may discover a MAC address, model number, or other information about a neighboring device and provide this information to an outside system in a query. The outside system, in response, may identify to the device the type of one or more of its neighboring devices, from which the device 105a can determine whether the device 105a can collaborate with the other device(s) to generate a random forest for use in anomaly detection at the device 105a. In other cases, the device (e.g., 105a) may determine locally which neighboring devices to exchange decision trees with for generating a random forest. For instance, the device may discover capabilities or type of a device based on communications exchanged in a discovery protocol of the network. In still other examples, a management system (e.g., responsible for deploying the IoT application) may determine groupings of devices in which decision trees should be exchanged and may communicate these group assignments to the individual devices (e.g., 105a-k) to identify which other devices each individual device should exchange decision trees with the support the development of corresponding random forest models, among other examples.

Physical proximity and other characteristics may be considered in determining which devices to exchange decision trees with. For example, in FIG. 8, it may be determined that a device 105a is to collaborate with devices 105b-e, such that device 105a shares its trained decision trees with each of devices 105b-e and receives shared decision trees from each of devices 105b-e. In one example, it may be determined that each of devices 105a-e both possess similar functionality to generate sufficiently similar data instances (e.g., from similar combinations of sensors, actuators, activity logic, etc. on the devices 105a-e) and are positioned within similar environments. On this example basis, it may be expected that decision trees developed for and trained using this set of devices (e.g., 105a-e) may be sufficiently similar and relevant to each of the devices. Accordingly, a determination may be made (at the device 105a or a remote management system, etc.) that device 105a should exchange decision tables with devices 105a-e to generate a random forest usable to reliably detect anomalies at the device 105a.

In some cases, criteria may be defined for determining whether a device should share its decision tables with another device or not. The criteria may indicate a level of similarity in the functional attributes of the devices, such that the decision trees maintained at each device produce decisions for comparable data instances. In some cases, the criteria may require that the devices are discrete instances of the same device or device type. In the case of device type, the devices may nonetheless be different, albeit sufficiently similar devices (e.g., different models, vendors, have some non-overlapping functional features, etc.). In general, the criteria may additionally specify environment attributes to be shared by the devices. For instance, anomalies affecting a device in one environment (e.g., a harsh outdoor environment) may not affect a different instance of the same device in another environment (e.g., an air-conditioned indoor environment). Further, anomaly detection models may be less applicable to devices that are not in close physical proximity and criteria may additionally dictate that devices that share decision trees should be within a defined proximity of the other (e.g., in a common physical environment). In some cases, proximity may be determined based on the ability of devices to communicate with each other (e.g., based on whether the other devices are within a limited wireless range of the device). In other cases, proximity may be determined from global positioning or other localization information determined for the devices. In general, criteria may be determined such that the decision trees maintained and trained at two or more different devices are sufficiently related such that each may be reliably used by other devices to predict anomaly events affecting data generated as the device.

Continuing with the example of FIG. 8, while proximity may be utilized to determine that device 105a is to share its decision tables with nearby devices 105b-e, other devices (e.g., 105k) in close proximity to device 105a may be excluded from such sharing based on the device (e.g., 105k) being functionally different (or of a different type) than devices 105a-e. Likewise, devices (e.g., 105f-j) that are instances of the same device model or device type, but that are deployed in a sufficiently different environment or not in proximity (e.g., communication range) of device 105a may also be excluded from sharing decision tables with device 105a. In some implementations, devices may be grouped for decision tree sharing. In other cases, each device may identify its own set of companion devices with which to exchange decision trees. For instance, while device 105c exchanges decision trees with device 105a, it may not necessarily exchange decision trees with other devices (e.g., 105b, 105d, 105e) with which device 105a shares. Further, in some implementations, some devices (e.g., 105c) may share decision tables with fewer companion devices (e.g., three) than others (e.g., 105a, which share with four), and as a result, the random tree model generated by some devices may be larger (e.g., incorporating more shared decision trees) than others. In some cases, some devices may host, train, and contribute larger numbers of decision trees than other devices, among other alternative implementations and features.

Random forest-based anomaly detection models may be initially generated in connection with a deployment of an IoT or WSN system. In some cases, the initial training of decision trees, decision tree exchange, random forest generation and validation may take place following a duration after deployment of the M2M system, to allow training and validation data to be developed for each of the participating devices. After corresponding random tree models have been generated, these trees may be used for a duration, before the composite decision trees are to be retrained to reflect any changes to the system (and anomaly distribution of each device and its corresponding environment). In one implementation, a first interval may be defined at which new updated training data is to be developed (from operation of a device) and used to retrain or supplement the initial training of the decision trees delegated to that device for training. A second interval may defined at which an exchange of updated decision trees may be completed (e.g., following the updated training of the decision trees at the corresponding devices). Likewise, random forests resulting corresponding to the updated training data and training may be re-validated and new weightings and thresholds determined for each instance of the random forests. In some cases, subsequent decision tree exchanges may involve newly added devices, which may potentially contribute trained decision trees not previously included in the exchange (and resulting random forests), among other examples. In general, decision trees (and their corresponding) may be continuously updated and re-shared (e.g., at defined intervals) to allow continuous improvement and updating of the resulting random forest anomaly detection models.

While some of the systems and solution described and illustrated herein have been described as containing or being associated with a plurality of elements, not all elements explicitly illustrated or described may be utilized in each alternative implementation of the present disclosure. Additionally, one or more of the elements described herein may be located external to a system, while in other instances, certain elements may be included within or as a portion of one or more of the other described elements, as well as other elements not described in the illustrated implementation. Further, certain elements may be combined with other components, as well as used for alternative or additional purposes in addition to those purposes described herein.

Further, it should be appreciated that the examples presented above are non-limiting examples provided merely for purposes of illustrating certain principles and features and not necessarily limiting or constraining the potential embodiments of the concepts described herein. For instance, a variety of different embodiments can be realized utilizing various combinations of the features and components described herein, including combinations realized through the various implementations of components described herein. Other implementations, features, and details should be appreciated from the contents of this Specification.

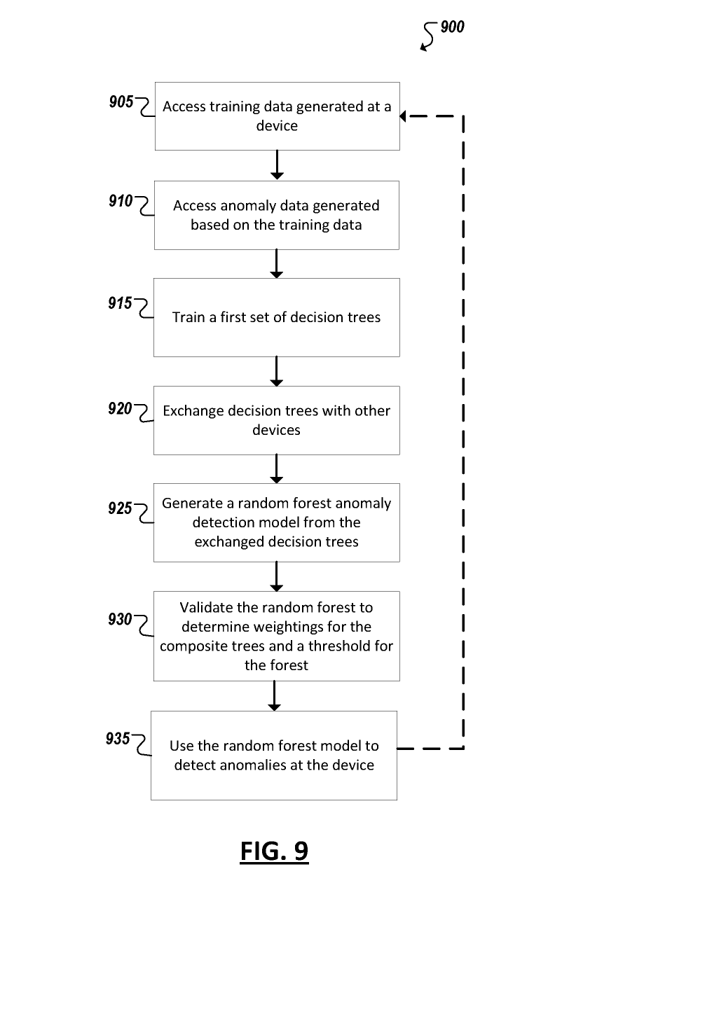

FIG. 9 is a simplified flowchart 900 illustrating an example technique for developing and using a random forest-based anomaly detection model for detecting anomalies at a device affecting data generated by the device (or particular sensors, logic, or actuators of the device, etc.). For instance, training data may be identified and accessed 905 that was generated (e.g., during operation) by a particular device. The training data may represent a one-class classification and anomaly data may be generated based on the training data to provide positive samples and labeling of the data set. The anomaly data may be identified and accessed 910 and combined with the training data for use in training 915 a set (e.g., a one or a plurality) of decision trees maintained locally at the device (e.g., as received from or assigned to the device by a management system). Upon training the data, a set of companion devices may be identified, which likewise maintain (and have trained) decision trees usable by the particular device to predict anomalies in data instances generated by the particular device. The decision trees trained by the particular device may be exchanged 920 with these companion devices, such that the particular device receives copies of the trained decision trees of the other devices and sends copies of its locally trained decision trees to the companion devices. Each device may then generate 925 a separate instance of a random forest-based anomaly detection model from the decision trees it exchanges with other (similar) devices in a system. Device-specific validation data may be applied to the composite trees in the device's instance of the random forest to validate 930 the model. Validation may include the determination, for each of the composite decision trees, a respective weighting (e.g., based on the degree to which the decision tree yields predictions consistent with a ground truth indicated in the validation data), as well as a threshold value to be compared against the combined, or ensemble, result (or vote) from the collection of decision trees in the random forest model. The validated random forest model may then be used 935, by logic executed at the device, to determine anomalies in data generated by the device. In some cases, steps 905-930 may be optionally repeated to continuously update and retrain the random forest model (e.g., according to a defined interval).

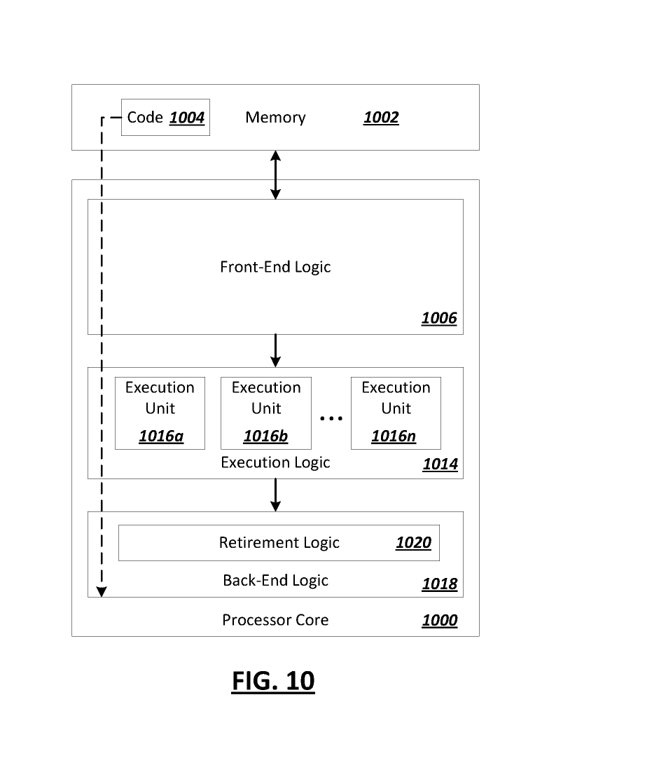

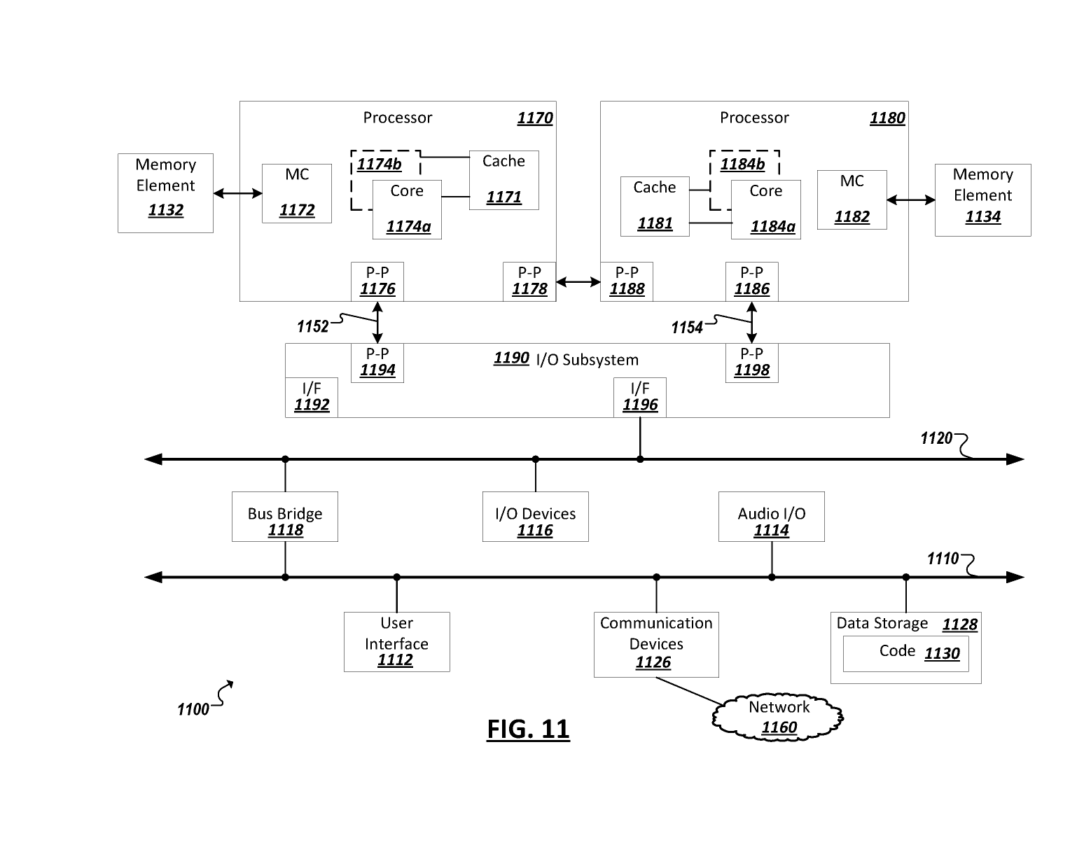

FIGS. 10-11 are block diagrams of exemplary computer architectures that may be used in accordance with embodiments disclosed herein. Other computer architecture designs known in the art for processors and computing systems may also be used. Generally, suitable computer architectures for embodiments disclosed herein can include, but are not limited to, configurations illustrated in FIGS. 10-11.

FIG. 10 is an example illustration of a processor according to an embodiment. Processor 1000 is an example of a type of hardware device that can be used in connection with the implementations above. Processor 1000 may be any type of processor, such as a microprocessor, an embedded processor, a digital signal processor (DSP), a network processor, a multi-core processor, a single core processor, or other device to execute code. Although only one processor 1000 is illustrated in FIG. 10, a processing element may alternatively include more than one of processor 1000 illustrated in FIG. 10. Processor 1000 may be a single-threaded core or, for at least one embodiment, the processor 1000 may be multi-threaded in that it may include more than one hardware thread context (or “logical processor”) per core.

FIG. 10 also illustrates a memory 1002 coupled to processor 1000 in accordance with an embodiment. Memory 1002 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 1000 can execute any type of instructions associated with algorithms, processes, or operations detailed herein. Generally, processor 1000 can transform an element or an article (e.g., data) from one state or thing to another state or thing.

Code 1004, which may be one or more instructions to be executed by processor 1000, may be stored in memory 1002, or may be stored in software, hardware, firmware, or any suitable combination thereof, or in any other internal or external component, device, element, or object where appropriate and based on particular needs. In one example, processor 1000 can follow a program sequence of instructions indicated by code 1004. Each instruction enters a front-end logic 1006 and is processed by one or more decoders 1008. The decoder may generate, as its output, a micro operation such as a fixed width micro operation in a predefined format, or may generate other instructions, microinstructions, or control signals that reflect the original code instruction. Front-end logic 1006 also includes register renaming logic 1010 and scheduling logic 1012, which generally allocate resources and queue the operation corresponding to the instruction for execution.

Processor 1000 can also include execution logic 1014 having a set of execution units 1016a, 1016b, 1016n, etc. Some embodiments may include a number of execution units dedicated to specific functions or sets of functions. Other embodiments may include only one execution unit or one execution unit that can perform a particular function. Execution logic 1014 performs the operations specified by code instructions.

After completion of execution of the operations specified by the code instructions, back-end logic 1018 can retire the instructions of code 1004. In one embodiment, processor 1000 allows out of order execution but requires in order retirement of instructions. Retirement logic 1020 may take a variety of known forms (e.g., re-order buffers or the like). In this manner, processor 1000 is transformed during execution of code 1004, at least in terms of the output generated by the decoder, hardware registers and tables utilized by register renaming logic 1010, and any registers (not shown) modified by execution logic 1014.

Although not shown in FIG. 10, a processing element may include other elements on a chip with processor 1000. For example, a processing element may include memory control logic along with processor 1000. The processing element may include I/O control logic and/or may include I/O control logic integrated with memory control logic. The processing element may also include one or more caches. In some embodiments, non-volatile memory (such as flash memory or fuses) may also be included on the chip with processor 1000.

FIG. 11 illustrates a computing system 1100 that is arranged in a point-to-point (PtP) configuration according to an embodiment. In particular, FIG. 11 shows a system where processors, memory, and input/output devices are interconnected by a number of point-to-point interfaces. Generally, one or more of the computing systems described herein may be configured in the same or similar manner as computing system 1100.

Processors 1170 and 1180 may also each include integrated memory controller logic (MC) 1172 and 1182 to communicate with memory elements 1132 and 1134. In alternative embodiments, memory controller logic 1172 and 1182 may be discrete logic separate from processors 1170 and 1180. Memory elements 1132 and/or 1134 may store various data to be used by processors 1170 and 1180 in achieving operations and functionality outlined herein.

Processors 1170 and 1180 may be any type of processor, such as those discussed in connection with other figures. Processors 1170 and 1180 may exchange data via a point-to-point (PtP) interface 1150 using point-to-point interface circuits 1178 and 1188, respectively. Processors 1170 and 1180 may each exchange data with a chipset 1190 via individual point-to-point interfaces 1152 and 1154 using point-to-point interface circuits 1176, 1186, 1194, and 1198. Chipset 1190 may also exchange data with a high-performance graphics circuit 1138 via a high-performance graphics interface 1139, using an interface circuit 1192, which could be a PtP interface circuit. In alternative embodiments, any or all of the PtP links illustrated in FIG. 11 could be implemented as a multi-drop bus rather than a PtP link.

Chipset 1190 may be in communication with a bus 1120 via an interface circuit 1196. Bus 1120 may have one or more devices that communicate over it, such as a bus bridge 1118 and I/O devices 1116. Via a bus 1110, bus bridge 1118 may be in communication with other devices such as a user interface 1112 (such as a keyboard, mouse, touchscreen, or other input devices), communication devices 1126 (such as modems, network interface devices, or other types of communication devices that may communicate through a computer network 1160), audio I/O devices 1114, and/or a data storage device 1128. Data storage device 1128 may store code 1130, which may be executed by processors 1170 and/or 1180. In alternative embodiments, any portions of the bus architectures could be implemented with one or more PtP links.

The computer system depicted in FIG. 11 is a schematic illustration of an embodiment of a computing system that may be utilized to implement various embodiments discussed herein. It will be appreciated that various components of the system depicted in FIG. 11 may be combined in a system-on-a-chip (SoC) architecture or in any other suitable configuration capable of achieving the functionality and features of examples and implementations provided herein.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Additionally, other user interface layouts and functionality can be supported. Other variations are within the scope of the following claims.

In general, one aspect of the subject matter described in this specification can be embodied in methods and executed instructions that include or cause the actions of identifying a sample that includes software code, generating a control flow graph for each of a plurality of functions included in the sample, and identifying, in each of the functions, features corresponding to instances of a set of control flow fragment types. The identified features can be used to generate a feature set for the sample from the identified features

These and other embodiments can each optionally include one or more of the following features. The features identified for each of the functions can be combined to generate a consolidated string for the sample and the feature set can be generated from the consolidated string. A string can be generated for each of the functions, each string describing the respective features identified for the function. Combining the features can include identifying a call in a particular one of the plurality of functions to another one of the plurality of functions and replacing a portion of the string of the particular function referencing the other function with contents of the string of the other function. Identifying the features can include abstracting each of the strings of the functions such that only features of the set of control flow fragment types are described in the strings. The set of control flow fragment types can include memory accesses by the function and function calls by the function. Identifying the features can include identifying instances of memory accesses by each of the functions and identifying instances of function calls by each of the functions. The feature set can identify each of the features identified for each of the functions. The feature set can be an n-graph.

Further, these and other embodiments can each optionally include one or more of the following features. The feature set can be provided for use in classifying the sample. For instance, classifying the sample can include clustering the sample with other samples based on corresponding features of the samples. Classifying the sample can further include determining a set of features relevant to a cluster of samples. Classifying the sample can also include determining whether to classify the sample as malware and/or determining whether the sample is likely one of one or more families of malware. Identifying the features can include abstracting each of the control flow graphs such that only features of the set of control flow fragment types are described in the control flow graphs. A plurality of samples can be received, including the sample. In some cases, the plurality of samples can be received from a plurality of sources. The feature set can identify a subset of features identified in the control flow graphs of the functions of the sample. The subset of features can correspond to memory accesses and function calls in the sample code.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The following examples pertain to embodiments in accordance with this Specification. One or more embodiments may provide a method, a system, apparatus, and a machine readable storage medium with stored instructions executable to identify training data including data generated at a particular device to be deployed in a machine-to-machine network, use the training data to train a first plurality of decision trees for inclusion in a random forest model, send copies of the trained first plurality of decision trees to at least one other device to also be deployed in the machine-to-machine network, receive copies of a second plurality of decision trees from the other device trained using training data generated by the other device, and generate the random forest model to include the first and second plurality of decision trees. The resulting random forest model is configured to be used by logic executed at the particular device to detect anomalies in data generated by the particular device.

In one example, the copies of the trained first plurality of decision trees are sent by the particular device to the other device and the random forest model is generated at the particular device.

In one example, the copies of the trained first plurality of decision trees are sent by the particular device to the other device over a wireless network connection.

In one example, the other device also generates the random forest model from the second plurality of decision trees and the copies of the trained first plurality of decision trees.

In one example, the random forest model is used to predict whether a particular data instance generated at the particular device is an anomaly.

In one example, an indication of the anomaly is sent from the particular device to a remote management system in response to a prediction that the particular data instance is an anomaly.

In one example, using the random forest model to predict whether a particular data instance generated at the particular device is an anomaly includes determining a decision for each decision tree in the random forest model, and using the decisions to determine a prediction for the particular data instance.

In one example, using the random forest model to predict whether a particular data instance generated at the particular device is an anomaly further includes identifying a respective weighting to be applied to each of the decisions of the decision trees of the random forest model, where the decision of each decision tree includes a weighted decision value based at least in part on the corresponding respective weighting, and the prediction includes a median weighted decision value determined from the weighted decision values of the decision trees of the random forest model, and the median weighted decision value is compared to a threshold value corresponding to an anomaly determination.

In one example, each of the first plurality of decision trees is validated using a validation data set to determine the respective weighting for each of the decision trees in the first plurality of decision trees. In some examples, all of the decision trees included in the random forest model are validated using the validation data set.

In one example, the threshold is determined based at least in part on validating the first plurality of decision trees using the validation data set.

In one example, each of the decision trees in the random forest model is validated using the validation data set, and the threshold is based at least in part on validating all of the decision trees in the random forest model.

In one example, the validation data set is generated at the device.

In one example, outlier training data is identified that is generated by outlier generation logic based on the training data, where the outlier training data is combined with the training data to form a training data set and the training data set is used to train the first plurality of decision trees.

In one example, each decision tree in the first plurality of decision trees is different from the decision trees in the second plurality of decision trees.

In one example, each decision tree in the first and second pluralities of decision trees is usable to generate a respective prediction of whether a data instance is an anomaly.

In one example, a group of devices is identified including the particular device and the at least one other device, where the particular device is to exchange decision trees with each other device in the group and the random forest model is to comprise decision trees received from the other devices in the group.

In one example, identifying the group of devices includes determining a set of devices in proximity of the particular device, determining a type of each of the set of devices, and determining that a subset of the set of devices determined to be in proximity of the particular device and of a type similar to a particular type of the particular device are to be included in the group of devices.

In one example, the type of device corresponds to one or more types of data generated by a device.

One or more embodiments may provide an apparatus that includes a processor, a memory, a sensor device to sense attributes of an environment and generate data to identify the attributes, decision tree training logic, tree sharing logic, model generation logic, and anomaly detection logic. The decision tree training logic may be executable to identify training data including data generated by the sensor device, identify anomaly data generated based on the training data to represent anomalous data instance values, and use the training data and anomaly data to train a first plurality of decision trees. Tree sharing logic may be executable by the processor to send copies of the trained first plurality of decision trees to a set of other devices in a machine-to-machine network, and receive copies of at least a second plurality of trained decision trees from the set of other devices. Model generation logic may be executable by the processor to generate a random forest from the first plurality of decision trees and the copies of the second plurality of trained decision trees. Anomaly detection logic may be executable by the processor to use the random forest to determine whether a particular data instance generated at least in part by the sensor device includes an anomaly.

In one example, each of the devices in the set of other devices provides respective copies of a plurality of decision trees, each of the pluralities of decision trees are to be included in the random forest, and each of the decision trees in the pluralities of decision trees are usable to generate a respective prediction of whether the particular data instance is an anomaly.

In one example, the data instance includes a vector.

In one example, the apparatus further includes another device to generate data and the vector includes a value of data generated by the sensor device and a value of data generated by the other device corresponding to a particular time instance.

In one example, the other device includes at least one of an actuator or another sensor device.

In one example, the apparatus further includes a battery-powered Internet of Things (IoT) device.

One or more embodiments may provide a system including a plurality of devices in a machine-to-machine network including a first device including a first set of sensors and logic to use first training data to train a first plurality of decision trees for inclusion in a random forest model, where the first training data includes data generated by the first set of sensors, send copies of the trained first plurality of decision trees to a second device in the machine-to-machine network, receive copies of a second plurality of decision trees from the second device, generate a first instance of the random forest model from the first and second plurality of decision trees, and detect anomalies in data generated by the first set of sensors using the first instance of the random forest model. The system may further include the second device, which may include a second set of sensors and logic to use second training data to train the second plurality of decision trees prior to sending to the first device, where the second training data includes data generated by the second set of sensors, generate a second instance of the random forest model from the first and second plurality of decision trees, and detect anomalies in data generated by the second set of sensors using the second instance of the random forest model

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

1. At least one machine accessible storage medium having instructions stored thereon, the instructions when executed on a machine, cause the machine to:
identify training data comprising data generated at a particular device to be deployed in a machine-to-machine network;
use the training data to train a first plurality of decision trees for inclusion in a random forest model;
send copies of the trained first plurality of decision trees to at least one other device to also be deployed in the machine-to-machine network;
receive copies of a second plurality of decision trees from the other device, wherein the second plurality of decision trees comprises decision trees trained using training data generated by the other device; and
generate the random forest model to comprise the first and second plurality of decision trees, wherein the random forest model is to be used by logic executed at the particular device to detect anomalies in data generated by the particular device.

2. The storage medium of claim 1, wherein the copies of the trained first plurality of decision trees are sent by the particular device to the other device and the random forest model is generated at the particular device.

3. The storage medium of claim 2, wherein the copies of the trained first plurality of decision trees are sent by the particular device to the other device over a wireless network connection.

4. The storage medium of claim 3, wherein the other device also generates the random forest model from the second plurality of decision trees and the copies of the trained first plurality of decision trees.

5. The storage medium of claim 2, wherein the instructions when executed further cause the machine to use the random forest model to predict whether a particular data instance generated at the particular device is an anomaly.

6. The storage medium of claim 5, wherein the instructions when executed further cause the machine to send, in response to a prediction that the particular data instance is an anomaly, an indication of the anomaly from the particular device to a remote management system.

7. The storage medium of claim 5, wherein using the random forest model to predict whether a particular data instance generated at the particular device is an anomaly comprises:
determining a decision for each decision tree in the random forest model; and
using the decisions to determine a prediction for the particular data instance.

8. The storage medium of claim 7, wherein using the random forest model to predict whether a particular data instance generated at the particular device is an anomaly further comprises:
identifying a respective weighting to be applied to each of the decisions of the decision trees of the random forest model, wherein the decision of each decision tree comprises a weighted decision value based at least in part on the corresponding respective weighting, and the prediction comprises a cumulative weighted decision value determined from the weighted decision values of the decision trees of the random forest model; and
comparing the cumulative weighted decision value to a threshold value corresponding to an anomaly determination.

9. The storage medium of claim 8, wherein the instructions when executed further cause the machine to validate each of the first plurality of decision trees using a validation data set to determine the respective weighting for each of the decision trees in the first plurality of decision trees.

10. (canceled)

11. The storage medium of claim 9, wherein the instructions when executed further cause the machine to validate at least a subset of the decision trees in the random forest model using the validation data set, and the threshold is based at least in part on validation of decision trees in the random forest model.

12. (canceled)

13. The storage medium of claim 1, wherein the instructions when executed further cause the machine to identify outlier training data generated by outlier generation logic based on the training data, wherein the outlier training data is combined with the training data to form a training data set and the training data set is used to train the first plurality of decision trees.

14. (canceled)

15. (canceled)

16. The storage medium of claim 1, wherein the instructions when executed further cause the machine to identify a group of devices comprising the particular device and the at least one other device, wherein the particular device is to exchange decision trees with each other device in the group and the random forest model is to comprise decision trees received from the other devices in the group.

17. The storage medium of claim 16, wherein identifying the group of devices comprises:
determining a set of devices in proximity of the particular device;
determining a type of each of the set of devices; and
determining that a subset of the set of devices determined to be in proximity of the particular device and of a type similar to a particular type of the particular device are to be included in the group of devices.

18. The storage medium of claim 17, wherein the type of device corresponds to one or more types of data generated by a device.

19. An apparatus comprising:
a processor;
a memory;
a sensor device to sense attributes of an environment and generate data to identify the attributes;
decision tree training logic, executable by the processor to:
identify training data comprising data generated by the sensor device;
identify anomaly data generated based on the training data to represent anomalous data instance values; and
use the training data and anomaly data to train a first plurality of decision trees;
tree sharing logic, executable by the processor to:
send copies of the trained first plurality of decision trees to a set of other devices in a machine-to-machine network; and
receive copies of at least a second plurality of trained decision trees from the set of other devices;
model generation logic, executable by the processor to generate a random forest from the first plurality of decision trees and the copies of the second plurality of trained decision trees; and
anomaly detection logic, executable by the processor to use the random forest to determine whether a particular data instance generated at least in part by the sensor device comprises an anomaly.

20. The apparatus of claim 19, wherein each of the devices in the set of other devices provides respective copies of a plurality of decision trees, each of the pluralities of decision trees are to be included in the random forest, and each of the decision trees in the pluralities of decision trees are usable to generate a respective prediction of whether the particular data instance is an anomaly.

21. The apparatus of claim 19, wherein the data instance comprises a vector.

22. The apparatus of claim 21, further comprising another device to generate data and the vector comprises a value of data generated by the sensor device and a value of data generated by the other device corresponding to a particular time instance.

23. The apparatus of claim 22, wherein the other device comprises at least one of an actuator or another sensor device.

24. (canceled)

25. A system comprising:
a plurality of devices in a machine-to-machine network comprising:
a first device comprising a first set of sensors and logic to:
use first training data to train a first plurality of decision trees for inclusion in a random forest model, wherein the first training data comprises data generated by the first set of sensors;
send copies of the trained first plurality of decision trees to a second device in the machine-to-machine network;
receive copies of a second plurality of decision trees from the second device;
generate a first instance of the random forest model from the first and second plurality of decision trees; and
detect anomalies in data generated by the first set of sensors using the first instance of the random forest model; and
the second device comprising a second set of sensors and logic to:
use second training data to train the second plurality of decision trees prior to sending to the first device, wherein the second training data comprises data generated by the second set of sensors;
generate a second instance of the random forest model from the first and second plurality of decision trees; and
detect anomalies in data generated by the second set of sensors using the second instance of the random forest model.
